(19) United States
(12) Patent Application Publication
(10) Pub. No.: US 2003/0018547 A1
(43) Pub. Date: Jan. 23, 2003

(54) Electronic supply logistics system

(76) Inventor: Mark A. Steele, Lantau Island (HK)

Correspondence Address: Paul E. Schaafsma, FOLEY & LARDNER, One IBM Plaza, 330 N. Wabash, Suite 3300, Chicago, IL, 60611, US

(21) Appl. No.: 09/761,517

(22) Filed: Jan. 16, 2001

(51) Int. Cl. G06F 17/60

(52) U.S. Cl. 705/29; 705/28; 705/26

(57) ABSTRACT

The present invention provides a supply logistics system. A customer 12 orders product by electronic communication. The purchase order is electronically routed to a vendor 16 for order fulfillment. An inbound shipment alert is electronically sent to a shipping agent 18. The vendor 16 fills the purchase order with inventory and ships the inventory to a shipping agent 18. The shipping agent 18 matches the inbound shipping alert with individual purchaser orders contained on the inventory, re-labels the inventory, and ships the inventory to the customer 12.

### FIELD OF INVENTION

The present invention relates in general to electronic supply logistics systems and in particular to a business-to-business-to-business system for ordering, managing, filling and shipping supplies via the Internet

### BACKGROUND OF INVENTION

While many large companies have created electronically enabled ordering systems, the scale needed to justify the investment of supporting architecture, processes and support personnel have put such efficiencies out of reach of many smaller manufacturers. In addition, since smaller manufacturers often rely on multiple partners in the supply chain, the costs of electronic enabled ordering systems for smaller manufacturers can be greater then for large companies.

This is also true of the more recent use of the Internet to facilitate electronic commerce technologies. The Internet is a global network of computers. Network servers support hypertext capabilities that permit the Internet to link together webs of documents. User interfaces such as Graphical User Interfaces (GUI) are typically used to navigate the Internet to retrieve relevant documents. Uniform Resource Locators (URLs) are used to identify specific web sites and web pages on the Internet. URLs identify the address of the document to be retrieved from a network server. The Transfer Control Protocol/Internet Protocol (TCP/IP) is used to transfer information.

The Internet uses a hypertext language referred to as the hypertext markup language (HTML). HTML is a commonly used scripting or programming language that permits content providers or developers to place hyperlinks within web pages. These hyperlinks link related content or data, which may be found on multiple Internet host computers. HTML document links may retrieve remote data by use of Hypertext Transfer Protocol (HTTP). Alternatively, File Transfer Protocol (FTP), Gopher, or other Internet application protocols can be used. When a user clicks on a link in a web document, the link icon in the document contains the URL that the client employs to initiate the session with the server storing the linked document. HTTP is the protocol used to support the information transfer.

While most of today's users of the Internet believe it is a recent communications phenomenon, the origins of the Internet actually go back several decades. Today's Internet grew out a computer resource-sharing network created in the 1960s by the Advanced Research Projects Agency (ARPA). This computer resource-sharing network, which came to be known as the ARPNet, was primarily designed by ARPA's chief scientist, Larry Roberts. The initial problem facing a wide-area computer resource-sharing network was how to efficiently transmit digitized information in a reliable way. To solve this problem, in 1968, Roberts mandated use of a packet-switching design in the ARPNet.

Packet switching breaks up blocks of digitized information into smaller pieces called packets. These packets are transmitted through the network, usually by different routes, and are then reassembled at their destination. Eight years prior to ARPA's RFP, Len Kleinrock invented packet switching. See e.g. Len Kleinrock, “Information Flow in Large Communications Nets,” RLE Quarterly Progress Report (1960); Len Kleinrock, Communication Nets (1964). See also Paul Baren, “On Distributed Communications Networks,” IEEE Transactions on Systems (March 1964). Roberts believed that packet switching was the means to efficiently transmit digitized information in a reliable way.

The next problem to solve was how to interconnect a number of mainframe computers, most of which utilized different languages and different operating systems. Wesley Clark of Washington University in St. Louis, Mo., devised the solution to this huge incompatibility problem. Clark proposed that a smaller microcomputer should interface between every mainframe and the network. All of these minicomputers would run on the same operating system and use the same language. Each mainframe, therefor, would only be required to interface with its own minicomputer, with the minicomputer translating into the network operating system and language. These Interface Message Processors (IMP), which provided an interface between the Aren't host mainframe computers and the Aren't, were the predecessors to today's routers. With this basic design, the first two nodes on the ARPNet communicated on Oct. 1, 1969.

By 1971, 15 nodes, mostly academic institutions, were up on the ARPNet. However, the original goal of the ARPNet was not being realized. Resource sharing of the mainframe computers was simply too cumbersome. In March 1972, however, Ray Tomlinson of Bolt, Beranek & Newman invented e-mail. Use of this message transfer program quickly grew to be the initial major use of the ARPNet.

By the mid-seventies, the ARPNet was not the only network utilizing switching packets. Once again, an incompatibility problem emerged. Each of these different networks used a different protocol. Thus, interconnection of these different networks was not possible. The solution, devised by Robert Kahn of ARPA and Vincent Cerf of Stanford University, was called the Transmission Control Protocol/Internet Protocol. The Transmission Control Protocol packetized information and reassembled the information upon arrival. The Internet Protocol routed packets by encasing the packets between networks. See e.g. Robert Kahn and Vincent Cerf, “A Protocol for Packet Network Intercommunication,” IEEE Transactions on Communications Technology (May 1974). Transmission Control Protocol/Internet Protocol was adopted by the ARPNet in 1983. With the addition of the Domain Name System (DNS) in November 1983, the now familiar Internet address protocol was established.

A final step in creating the Internet occurred in 1990, when an Englishman, Tim Berners-Lee of the European Center for Particle Research (CERN) in Switzerland, invented the World Wide Web. This software, based on a program Berners-Lee had written in 1980 to allow users to store information using random associations, allowed material from any computer, from any format to be translated into a common language of words, images and addressed. Berners-Lee's program established the three core components of the World Wide Web: the Universal Resource Locator, Hypertext Transfer Protocol, and HyperText Markup language.

While the initial focus of e-commerce technologies on the Internet was to facilitate business to consumer (B2C) transactions, increasingly businesses are finding economies in transacting business to business (B2B) over the Internet. However, such business to business transactions over the Internet have proven largely unsatisfactory for assisting multiple partners in the supply chain.

Thus what is needed is an efficient electronic supply logistics system capable of servicing multiple vendors and customers. The electronic supply logistics system should provide for efficient ordering, managing, filling and shipping of supplies. The electronic supply logistics system should provide for efficiencies for smaller manufacturers without requiring large resource allocation. The electronic supply logistics system should be capable of handling multiple partners in the supply chain.

### SUMMARY OF THE INVENTION

The present invention provides a supply logistics system that provides an efficient electronic system capable of servicing multiple vendors and customers. The electronic supply logistics system of the present invention provides for efficient ordering, managing, filling and shipping of supplies. The electronic supply logistics system of the present invention provides for efficiencies for smaller manufacturers without requiring large resource allocation. The electronic supply logistics system of the present invention is capable of handling multiple partners in the supply chain.

In a supply logistics system in accordance with the principles of the present invention, a customer orders product by electronic communication. The purchase order is electronically routed to the vendor for order fulfillment. An inbound shipment alert is electronically sent to a shipping agent. The vendor fills the purchase order with inventory and ships the inventory to a shipping agent. The shipping agent matches the inbound shipping alert with individual purchaser orders contained on the inventory, re-labels the inventory, and ships the inventory to the customer.

### BRIEF DESCRIPTION OF THE DRAWINGS

FIG. 1 is a diagrammatic overview of a supply logistics system in accordance with the principles of the present invention.

FIG. 2 is an overview of hardware utilized in a preferred embodiment of the present invention.

FIG. 3 is a diagram of the logistic information flow of a user of a supply logistics system in accordance with the principles of the present invention.

FIG. 4 is a flow diagram of the web-site navigational and workflow of an Internet enabled embodiment in accordance with the principles of the present invention.

### DETAILED DESCRIPTION OF THE PREFERRED EMBODIMENTS

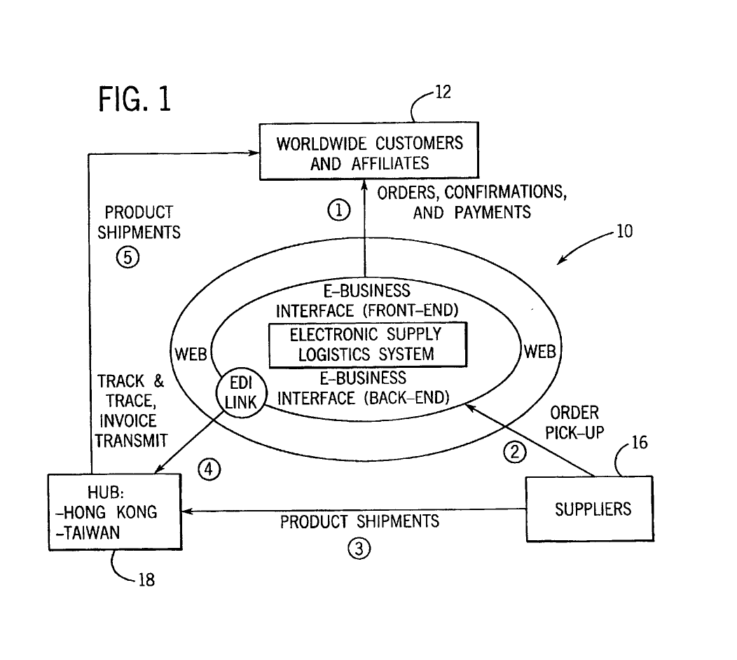

Referring first to FIG. 1, a diagrammatic overview of a supply logistics system in accordance with the principles of the present invention is designated generally by the reference numeral 10. Customers 12 initiate orders of products by electronic communication with a logistics manager. Suppliers or vendors 16 fill the orders. A shipping agent 18 ships the orders to the customer 12. In a preferred embodiment, electronic communication is via a networked system such as a local area network or a wide area network. In a further preferred embodiment, the networked system is via an Internet enabled interface.

The electronic communication provides an instant order confirmation electronically to the ordering customer 12. Once an order is received, the order is electronically routed to the vendors 16. In a preferred embodiment, this electronic routing is via the Internet enabled interface. Each electronic order includes an electronic locator. In the Internet enabled embodiment, each electronic order includes an order specific uniform resource locator (URL). The vendor 16 utilizes this URL to link to the Internet enabled interface where they acknowledge receipt of the order.

After filling the electronic order, the vendor 16 ships the products directly to the shipping agent 18. In a preferred embodiment, the shipping agent 18 is an independent shipping company. The shipping agent 18 designates a distribution hub to which the products are shipped. Upon receipt of the goods, the shipping agent 18 re-labels the products, swaps the vendor invoice with an invoice issued by the logistics manager, consolidates shipments, and prepares any required export customs documentation. In a preferred embodiment, shipping management software utilized by the shipping agent 18 is integrated into the electronic communication network. Thus, in the Internet enabled embodiment, customers 12 can access and track the status of their shipments via the Internet. The shipment to the ordering customers 12 is the responsibility of the shipping agent 18.

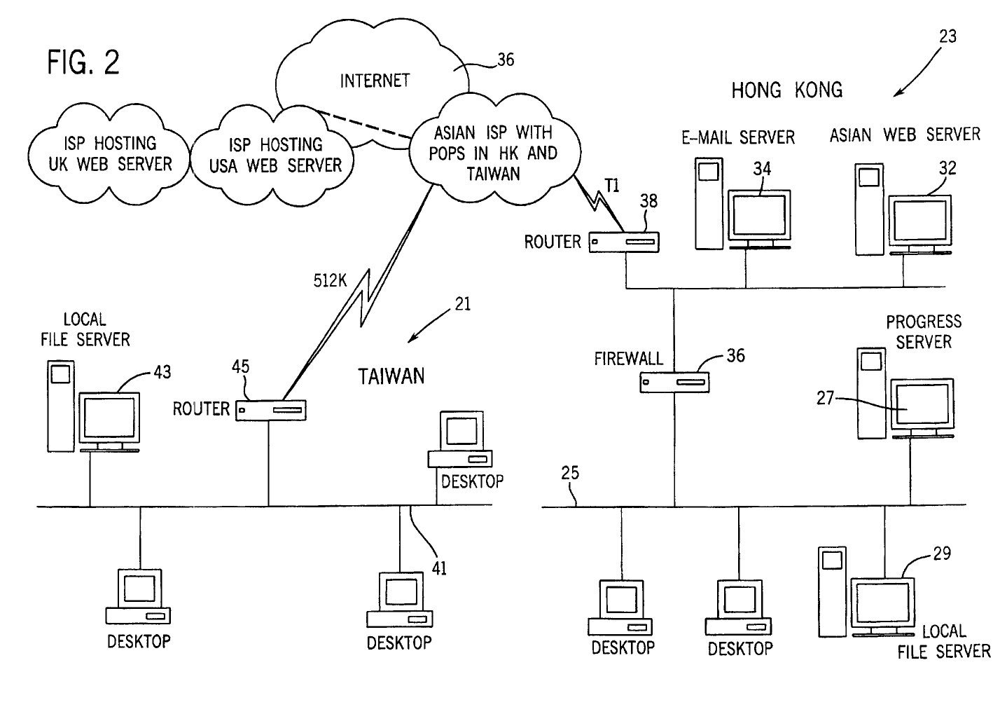

Referring now to FIG. 2, an overview of hardware utilized in a preferred embodiment of the present invention is seen. In the example set forth herein, the system encompasses two functional locations, with one location facilitating vendor management 21 and one location facilitating system management 23. At the system management 23 location, a local area network 25 is provided. The local area network 25 includes a progress server 27 and a local file server 29. The local area network 25 is connected to a web server 32 and an e-mail server 34 through a firewall 36. The web server 32 and the e-mail server 34 are connected to the Internet 36 via a router 38.

At the vendor management 21 location, a local area network 41 is provided which includes a local file server 43. The local area network 41 is connected to the Internet 36 via a router 45. While the two functional locations are described herein as two separate geographical locations, the present invention contemplates the same geographical location of the two functional locations.

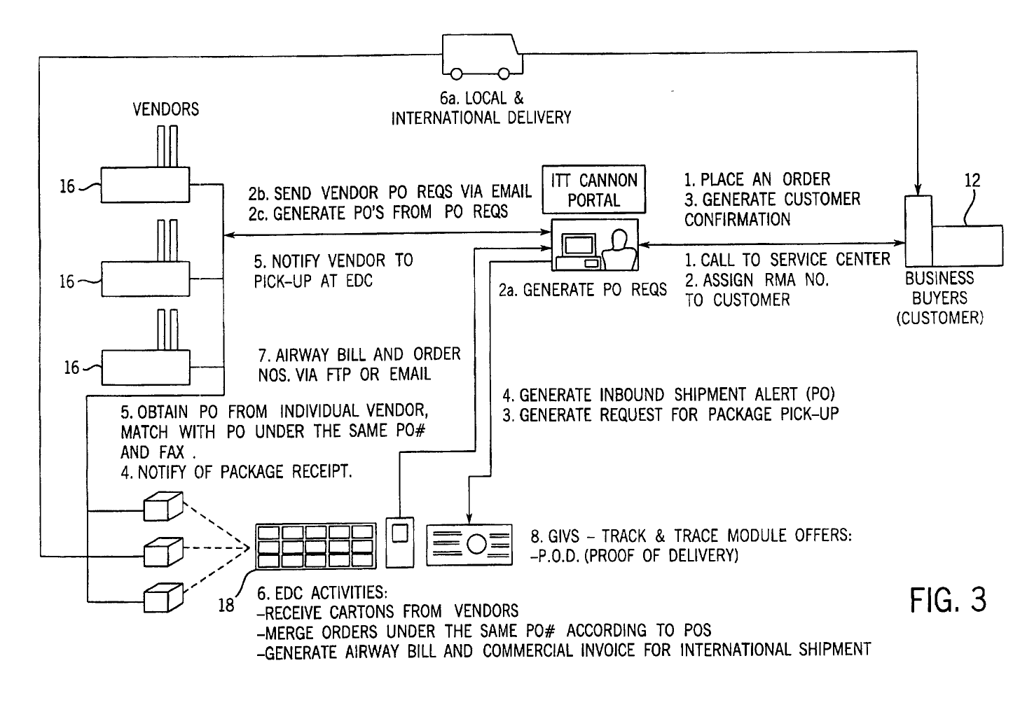

Referring now to FIG. 3, the logistic information flow of a user order in accordance with the principles of the present invention is seen. Initially, a customer 12 places an order. In a preferred embodiment, an electronic shopping cart is used, as described in detail below. In response to the selection, the system generates an electronic purchase order and sends this electronic purchase order to the appropriate vendor 16 for order fulfillment. In the preferred embodiment, the electronic purchase order is sent to the vendor via e-mail.

Upon receipt and confirmation by the vendor 16 of the electronic purchase order, a customer confirmation is generated and sent electronically to the ordering customer 12. A consolidated purchase order is electronically sent as an inbound shipment alert/demand order to the shipping agent 18.

When filling the purchase order requests, the vendor 16 ships the inventory to the shipping agent 18 to a designated distribution hub. The shipping agent 18 receives the crates from the vendors 16, which contain individual purchase orders per each customer order. The inventory is matched up with the individual purchase order attached to each carton of inventory. The shipping agent 18 then matches up the inbound shipping alert/demand order with the individual purchaser orders contained on the physical inventory. Once matching is completed, the shipping agent 18 sends an order acknowledging receipt electronically to the logistics manager. The shipping agent 18 also faxes copies of the individual purchase orders that were attached to the carton of physical inventory to the logistics manager.

The shipping agent 18 then generates a packing list and a commercial invoice based on the facilitator demand order, and ships the physical inventory with the logistic manager's invoice to the final customer 12. The shipping agent 18 gives the logistics manager electronic acknowledgement of the shipment of the order to the customer 12. After the shipping agent 18 ships the physical inventory, an interface that has been provided between the tracking system of the shipping agent 18 and the e-commerce system of the present invention allows both the facilitator and the customer 12 to track the shipping order in the shipment procedure.

The system of the present invention also provides for product returns. In accordance with the principals of the present invention, if a customer 12 wishes to initiate a product return, the customer 12 calls or accesses the customer service function of the logistics manager. Upon receipt of a return order, the system assigns a Return Material Authorization (RMA) number to the customer 12. The system then generates a request for product pick-up to the shipping agent 18. Upon receipt of the request for a package pick up, the shipping agent 18 picks up the physical inventory and notifies the logistics manager of return product receipt. Upon following notification of package receipt, the system notifies the vendor 16 to pick up the product return at the distribution hub of the shipping agent 18.

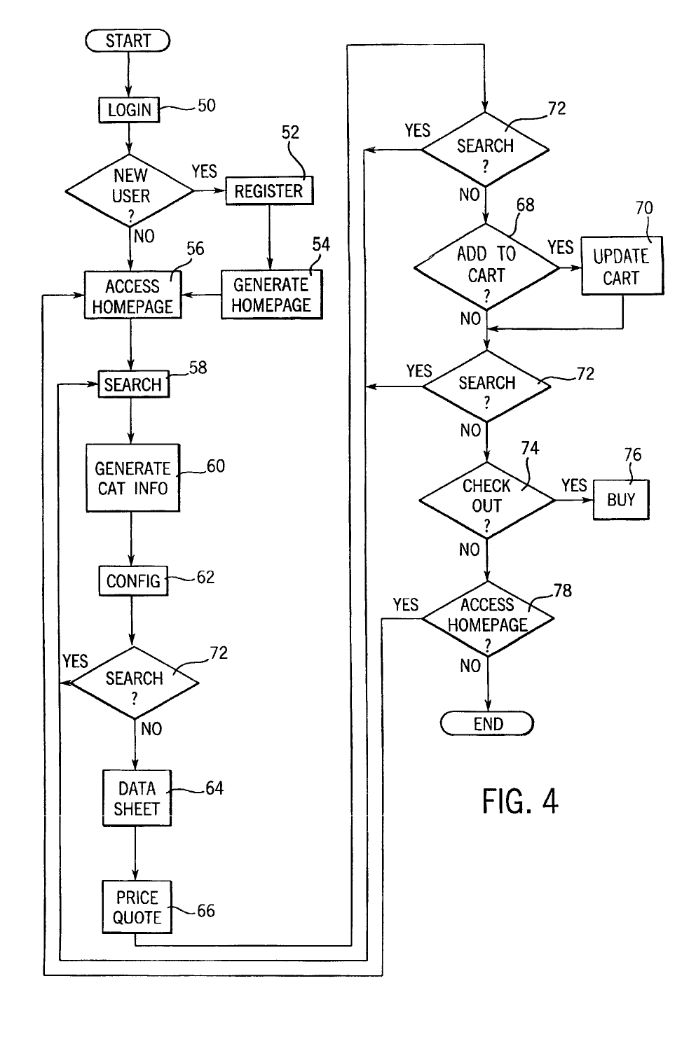

Referring now to FIG. 4, a top-level overview of the web-site navigational and workflow of the Internet enabled embodiment is seen. Initially upon accessing the web-site, background information about the logistics manager is provided to the user as well as background material on the system of the present invention. In order to proceed, the customer 12 logs into the system 50. If the customer 12 is a new user, the customer 12 is registered as a user 52. If the customer 12 is an existing user, the customer logs in using its personal identification number (PIN).

When a new user logs in, the system generates a user home page formatted specifically for that user 54. When an existing user logs in, the existing user accesses a user home page that had been previously generated upon registration of the existing user 56. The home page for an existing user can include features such as, for example, status of outstanding orders, billing history, service call requests, order shipment tracings, and access to saved shopping carts. Once logged in, the user can search for product offering 58. Searching parameters include, for example, searching by product or searching by application of the product.

Upon selection of a product offering, a catalog is generated containing an image of the selected product offering 60. A configurator configures the product offerings 62. In a preferred embodiment, the configurator is the configurator described in co-pending United States patent application Ser. No. ______ Web Based System and Method for Configuring and Determining Availability of Configurable Products filed ______ and assigned to the assignee of the present invention, the disclosure of which is incorporated herein by this reference. A product data sheet is also provided with respect to the product offering 64. If the user is interested in ordering the product and the user has logged in or registered as a new user, an on-line price quotation is provided 66. The user then has the option of adding the product to a shopping cart 68, in which case the shopping cart is updated 70.

At the configurator 62, the on-line quotation 66 or the shopping cart 68, the user can return to the search function to search for an additional product offering 72. If further searching is not desired, the user can then checkout 74 ands purchase 76 the merchandise in the shopping cart, or return 78 to the home page. The home page also includes links to informational and news topics related to the applicable industry and an identification of the vendor facilitator and an identification of the vendor facilitator, including a link to direct communications to the vendor facilitator.

While the invention has been described with specific embodiments, other alternatives, modifications and variations will be apparent to those skilled in the art. Accordingly, it is intended to include all such alternatives, modifications and variations set forth within the spirit and scope of the appended claims.

What is claimed is:

1. A supply logistics method comprising the steps of:
a customer ordering a product by electronic communication;
providing an order confirmation electronically to the customer;
electronically routing the order to a vendor; and
electronically sending an inbound shipment alert to a shipping agent.

2. The supply logistics method of claim 1 further wherein the electronic communication is via a networked system.

3. The supply logistics method of claim 2 further wherein the networked system is a local area network.

4. The supply logistics method of claim 2 further wherein the networked system is a wide area network.

5. The supply logistics method of claim 4 further wherein the wide area network is the Internet.

6. The supply logistics method of claim 1 further including the step of attaching a uniform resource locator (URL) to the electronic order.

7. The supply logistics method of claim 1 further wherein the shipping agent is an independent shipping company.

8. The supply logistics method of claim 1 further including the step of the shipping agent re-labeling the products.

9. The supply logistics method of claim 1 further including the step of the shipping agent consolidating shipments.

10. The supply logistics method of claim 1 further including the step of the shipping agent preparing required export customs documents.

11. The supply logistics method of claim 1 further including the step of generating a pack list and a commercial invoice based on the shipment alert.

12. The supply logistics method of claim 1 further including the step of electronically sending the purchase order as the inbound shipment alert to the shipping agent

13. The supply logistics method of claim 1 further including the step of acknowledging the shipment of the order.

14. The supply logistics method of claim 1 further including the step faxing copies of the purchase orders that were attached to the physical inventory to a logistics manager.

15. The supply logistics method of claim 1 further including the step of the customer tracking the status of the shipment.

16. The supply logistics method of claim 15 further including the step of the customer tracking the status via the Internet.

17. A supply logistics system comprising:
a vendor management location, the vendor management location including computer;
a system management location, the system management location including a computer;
the vendor management location and the system management location are in electronic communication with each other;
the vendor management location and the system management location being capable of establishing electronic communication with a vendor; and
the vendor management location and the system management location being capable of establishing electronic communication with a shipping agent.

18. The supply logistics system of claim 17 further wherein the vendor management location computer hosts a progress server.

19. The supply logistics system of claim 17 further wherein the vendor management location computer hosts a file server.

20. The supply logistics system of claim 17 further wherein the system management location computer hosts a file server.

21. The supply logistics system of claim 17 further wherein the system management location further includes a local area network.

22. The supply logistics system of claim 21 further wherein the local area network is connected to a web server.

23. The supply logistics system of claim 21 further wherein the local area network is connected to an e-mail server.

24. The supply logistics system of claim 17 further wherein the vendor management location further includes a local area network.

25. The supply logistics system of claim 17 further wherein the electronic communication is via a networked system.

26 The supply logistics system of claim 25 further wherein the networked system is a local area network.

27. The supply logistics system of claim 25 further wherein the networked system is a wide area network.

28. The supply logistics system of claim 27 further wherein the wide area network is the Internet.

29. The supply logistics system of claim 17 further wherein the vendor management location and the system management location are in geographic proximity.

30. A supply logistics method comprising:
receiving an order from a customer via electronic communication;
generating an electronic purchase order;
sending the electronic purchase order to a vendor for order fulfillment;
generating an electronic purchaser order from the purchase order requests sent to the vendor;
sending the electronic purchase order to the vendor; and
electronically sending an inbound shipment alert to a shipping agent.

31. The supply logistics method of claim 30 further wherein the electronic communication is via a networked system.

32. The supply logistics method of claim 31 further wherein the networked system is a local area network.

33. The supply logistics method of claim 31 further wherein the networked system is a wide area network.

34. The supply logistics method of claim 33 further wherein the wide area network is the Internet.

35. The supply logistics method of claim 30 further including the step of attaching a uniform resource locator (URL) to the electronic order

36. The supply logistics method of claim 30 further including the step of sending the electronic purchase order to the vendor via e-mail.

37. The supply logistics method of claim 30 further including the step of electronically sending the purchase order as the inbound shipment alert to the shipping agent.

38. The supply logistics method of claim 30 further including the step of sending to the customer a confirmation of the order.

39. A supply logistics method comprising:
receiving a purchase order for order fulfillment via electronic communication;
receiving an electronic purchaser order listing a plurality purchase order requests;
filling the purchase order with inventory; and
shipping the inventory to a shipping agent.

40. The supply logistics method of claim 39 further wherein the electronic communication is via a networked system.

41. The supply logistics method of claim 40 further wherein the networked system is a local area network.

42. The supply logistics method of claim 40 further wherein the networked system is a wide area network.

43. The supply logistics method of claim 42 further wherein the wide area network is the Internet.

44. The supply logistics method of claim 39 further including the step of including a uniform resource locator (URL) with the electronic order.

45. The supply logistics method of claim 39 further including the step of acknowledging the shipment of the order.

46. A supply logistics method comprising the steps of:
receiving an inbound shipment alert via electronic communication;
receiving inventory from a vendor;
matching the inbound shipping alert with individual purchaser orders contained on the inventory;
relabeling the inventory; and
shipping the inventory to a customer.

47. The supply logistics method of claim 46 further wherein the electronic communication is via a networked system.

48. The supply logistics method of claim 47 further wherein the networked system is a local area network.

49. The supply logistics method of claim 47 further wherein the networked system is a wide area network.

50. The supply logistics method of claim 49 further wherein the wide area network is the Internet.

51. The supply logistics method of claim 46 further including the step of consolidating shipments.

52. The supply logistics method of claim 46 further including the step of preparing required export customs documents.

53. The supply logistics method of claim 46 further including the step faxing copies of the purchase orders that were attached to the physical inventory to a logistics manager.

54. The supply logistics method of claim 46 further including the step of generating a pack list and a commercial invoice based on the shipment alert.

55. A product return method comprising:
receiving a return order from a customer;
generating a request for product pick-up to a shipping agent via electronic communication;
picking-up the product and delivering to a distribution hub; and
notifying a vendor to pick up the product return at the shipping agent's distribution hub.

56. The supply logistics method of claim 55 further wherein the electronic communication is via a networked system.

57. The supply logistics method of claim 56 further wherein the networked system is a local area network.

58. The supply logistics method of claim 56 further wherein the networked system is a wide area network.

59. The supply logistics method of claim 58 further wherein the wide area network is the Internet.

60. The product return method of claim 55 further including the step of notifying the logistics manager of return product receipt.
